(19) United States
(12) Patent Application Publication
(10) Pub. No.: US 2015/0220882 A1
(43) Pub. Date: Aug. 6, 2015

(54) ASSET CREATION AND UTILIZATION USING AN ASSET CREATION TOOL

(71) Applicant: International Business Machines Corporation, Armonk, NY (US)

(72) Inventors: Romelia H. Flores, Keller, TX (US); Leonard S. Hand, Red Creek, NY (US)

(73) Assignee: International Business Machines Corporation, Armonk, NY (US)

(21) Appl. No.: 14/171,403

(22) Filed: Feb. 3, 2014

(51) Int. Cl. G06Q 10/10

(52) U.S. Cl. CPC G06Q 10/103

(57) ABSTRACT

An embodiment of the present invention is a method of configuring an existing document creation program. The method comprises configuring an existing document creation program to format an asset with one or more portions of the asset such as a section, a subset or a group for entry into an asset system. The method also includes configuring the existing document creation program to identify to the asset system, a list of collaborators for each of the one or more portions of the asset and furthermore, configuring, the existing document creation program to identify, to the asset system, when a change in one or more of the portions of the asset may be determined for collaborator notification.

### FIELD OF THE INVENTION

The present invention relates generally to the field of modifying existing programs and more particularly to file creation and management.

### BACKGROUND OF THE INVENTION

In the current widespread computing environment, the creation, editing and consumption of an asset such as a presentation, document or file, for example, can occur virtually anywhere at any time. Many of the document creation programs commonly used have been in existence for some time and were developed for a single asset provider to create and manage an asset such as a document, presentation or file as a single entity. If multiple asset providers contributed to a single asset it was up to the asset provider to manage the edits of the document and notify the contributors or team members of updates. The asset provider may notify team members of changes to an asset by E-mail, instant messages, texting, or other social media content that may be accessed separately. However, recent changes in business practices have lead to team based business structures to quickly create large assets. These teams are often spread over large geographic areas, which can lead to difficulties in coordination when creating the large assets.

### SUMMARY

Embodiments of the present invention disclose a method, computer program product, and system for configuring an existing document creation program. The method comprises configuring an existing document creation program to format an asset, for entry into an asset system, with one or more portions of the asset. The method also includes configuring the existing document creation program to identify to the asset system, a list of collaborators and furthermore, the method also configures the existing document creation program to identify to the asset system when a change occurs in one or more of the portions of the asset for collaborator notification.

### BRIEF DESCRIPTION OF THE SEVERAL VIEWS OF THE DRAWINGS

FIG. 1 is a functional block diagram illustrating a data processing environment for an asset creation tool, in accordance with an embodiment of the present invention.

FIG. 2 is a schematic diagram illustrating an example of an asset creation tool generating an asset in accordance with an embodiment of the present invention.

FIG. 3 illustrates operational steps of an asset creation tool executing on a computer system within the data processing environment of FIG. 1, in accordance with an embodiment of the present invention.

FIG. 4 depicts an example of an extension provided by asset creation tool 122, in accordance with one embodiment of the present invention.

FIG. 5 depicts a block diagram of respective components of a server and the computer system utilizing an asset creation tool, of FIG. 1, in accordance with an embodiment of the present invention.

### DETAILED DESCRIPTION

Embodiments of the present invention provide a method, a computer program product and a system for improving current document creation programs to enable granular handling of portions of an asset such as sections, subsets, or groups within an asset for ease of identification, location and re-use of these granular elements. An asset may be an electronic document, a presentation or other similar electronic file. Embodiments of the invention propose the use of an asset creation tool which is a plug-in or interface to existing document creation programs such as Microsoft Office® or Lotus Symphony® for example, to augment current capabilities to enable the creation and identification of more granular elements of an asset. In addition, the asset creation tool configures current document creation programs to extend their capability to work seamlessly with an asset system.

Embodiments of the present invention enable the identification of sections, subsets, or groups of an asset. A portion of an asset can be one or more of a section, subset or group of an asset. The asset creation tool configures existing document creation programs to extend their capabilities to provide granular, identifiable elements with an identification of various content sections, subsets, or groups, as well as preferences for how to manifest that content within an asset system for customized asset provider selection and re-use. The de-composition or breaking down assets into smaller, identifiable portions of the asset allows asset providers or asset consumers to quickly locate desired asset data or elements for inclusion into their projects, documents or presentations. The granular, identifiable elements may include, but are not limited to, sections, subsets and groups that may include the use of: (i) tags, (ii) points of variability, and (iii) other user experience information to allow users to configure an asset within existing document creation programs to extend capabilities to locate and use desired content both within an asset and an asset system.

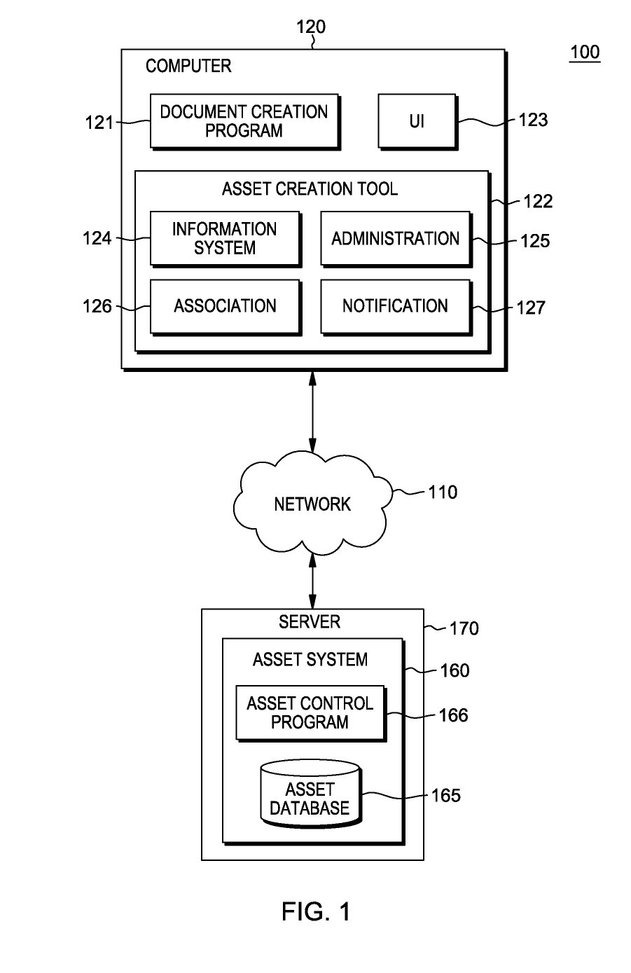

Embodiments of the present invention provide an asset creation tool that may be an interface, a plug-in, or other macro based approach for configuring a document creation program to enable granular access to identifiable elements of an asset for entry into an asset system. Identifiable portions of an asset may include a section, subset, or group. An asset system provides a method and environment to create, receive, edit, store, locate and manage assets including granular elements of assets, asset sections, asset subsets and/or asset groups for collaboration and use as discussed in more detail in FIG. 1.

Asset creation tools provide the capability to configure existing document creation programs to enable an asset provider to identify asset sections, subsets, groups, variables or other user experience information for asset creation within existing document creation programs and for use in an asset system. The asset creation tool may work with a new or existing file to identify asset sections, subsets, groups or other user experience information. The asset sections, subsets or groups may be manifested as “tabs”. Additionally, embodiments of the present invention make use of tags and points of variability to enable knowledge of how an asset provider wants to manifest the asset within an asset system, how to effectively represent an asset within the asset system, and what data is variable upon reuse of the asset once it is housed in the asset system. An asset creation tool extends capabilities of the document creation program to provide the ability to access data dynamically, in real-time so that an asset consumer can be enabled with up to date points of variability. The identification of variability points of an asset, asset section, asset subset or group may be done by the asset provider using tags and include embedded content both, static and dynamic, for example audio, video files or other electronic content. The identification of sections, subsets and groups within an asset as well as the identification of various content formats and points of variability are enabled by utilizing the asset creation tool. As one knowledgeable in the art would recognize, various content formats include tags for example that may identify the look of a document or presentation (font size, color, speaker or date) for each identified element (section, subset or group) of an asset. When utilizing the asset creation tool various content formats and points of variability may be stored with the asset both locally, and in the asset system associated with the asset. The asset system then utilizes the asset, asset sections, asset subsets, asset groups, tags, points of variability in the asset system to ensure appropriate placement of the asset, within the asset system as well as appropriate look and feel to the consumer when they leverage the asset system for asset reuse.

Additionally, the asset creation tool provides a configuration of the document creation program that enables the asset provider to identify collaborators working on other parts of the project or related projects. Collaborators may be identified by asset, section, subset or group to target selective notification to specific collaborators. When the updated asset or changes to the asset are saved, the asset may be formatted for entry into the asset system and then, sent to the asset system. When the asset is formatted and saved for entry into the asset system, a query may be generated to the asset provider, who may be another collaborator who is working a portion of the asset, to determine if a notification of a modification or change to the asset or to one or more portions of the asset such as a section, subset or group should be sent to the associated collaborators. Embodiments of the present invention provide a method to configure existing document creation programs to provide an environment for collaboration including a method for selective notification by an asset system to a collaborating team or an identified subset of the collaborating team in a timely, effective manner for identified asset changes.

The capability of the asset creation tool also includes the ability to configure existing document creation programs for submission of asset sections, subsets, groups and points of variability into an asset system. Selective, automatic notification of updates to an asset, an asset section, an asset subset or an asset group may be sent to the associated asset providers which are identified as collaborators by an asset system.

As will be appreciated by one skilled in the art, aspects of the present invention may be embodied as a system, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

The present invention will now be described in detail with reference to the Figures. FIG. 1 is a functional block diagram illustrating a data processing environment, generally designated 100, for improved asset creation and utilization using an asset creation tool in accordance with one embodiment of the present invention.

Data processing environment 100 includes computer 120 and server 170 connected via network 110.

Network 110 can be a distributed computing environment utilizing clustered computers and components that act as a single pool of seamless resources, as is common in data centers and with cloud computing applications or “cloud”. In other embodiments, network 110 may be implemented as a local area network (LAN), a virtual LAN (VLAN), a wide area network (WAN) such as the Internet, or a combination of these, and can include wired, wireless, or fiber optic connections. In general, network 110 can be any combination of connections and protocols that will support communications between computer 120 and server 170.

Server 170 may be, for example, a management server, a web server, or any other electronic device or computer system capable of receiving and sending data. In another embodiment, server 170 is a primary server for a computer system utilizing clustered computers and components to act as a single pool of seamless resources when accessed through network 110. Computer 120 is a client to server 170 and may be, for example, a notebook, a laptop computer, a personal digital assistant (PDA), a smartphone or any other electronic device or computer system capable of communicating with server 170 via network 110.

Server 170 is capable of receiving and sending electronic data including e-mail, presentation files or documents from computer 120 and other client computing devices not shown. Server 170 includes asset system 160 for document or file creation, editing, retrieval and additional management functions including notification of asset changes. Asset system 160 includes asset control program 166 and asset database 165.

Asset system 160 may receive and send electronic data, files, documents and electronic notifications which may include e-mail, text, twitter or similar notifications from and to computer 120 and other client computing devices. An asset system utilizes a method and provides environment to create, receive, edit, store, locate and manage assets including granular elements of assets, asset sections, asset subsets and/or asset groups for collaboration and use. Asset system 160 also utilizes a method for an asset provider to provide categorization into target assemblies for storage and retrieval, granular de-composition of assets into asset sections, asset subsets and asset groups, identification of collaborators by asset, asset section, asset subset, and/or asset group.

In addition, asset system 160 performs maintenance and security including monitoring, tracking and metrics on asset usage. Asset system 160 provides selective notification to identified asset providers or collaborators when changes are saved on an asset, an asset section, an asset subset, or an asset group. Asset system 160 utilizes asset control program 166 to receive electronic data, verify electronic data and file content, verify authorized access, and manage asset storage and entry into associated asset assembly within asset database 165. Asset control program 166 provides asset de-composition into granular elements such as asset sections, asset subset, and asset groups identified for example by metadata or tags. For example, a presentation on “World Economy” may have a section identified as “South American Economy”.

Asset control program 166 enables asset system 160 to provide: (i) asset variability points by asset section, asset subset or asset group, (ii) the ability to identify associated collaborators by asset section, subset or group, (iii) to provide notification of changes to assets, (iv) leverage search capability for individual asset sections, subsets and groups, (vi) to provide identified links, tabs and other user experience information. Asset control program 166 provides access to assets stored in asset database 165 and stores assets to asset database 165.

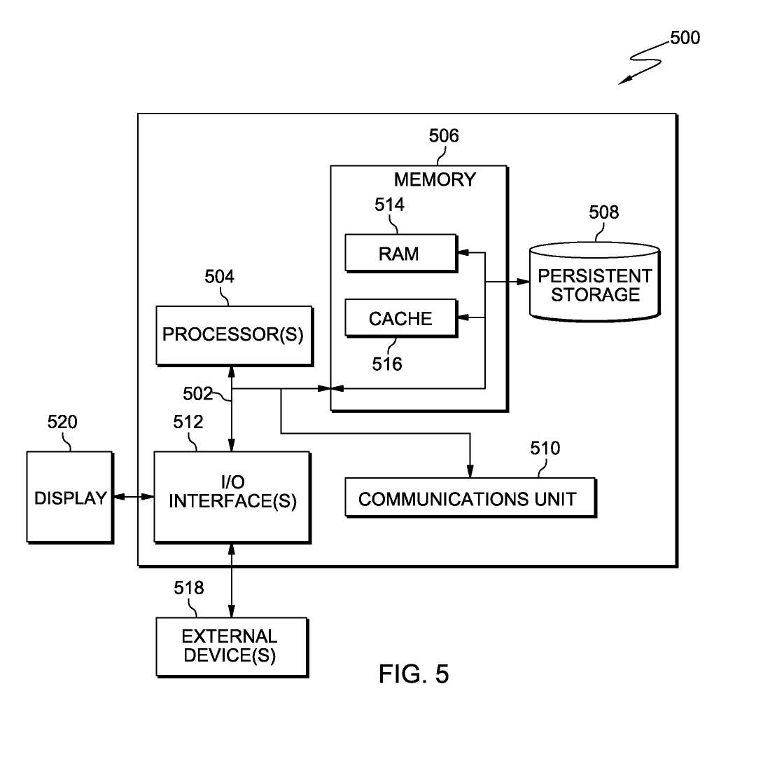

Computer 120 may be a laptop computer, a tablet computer, a netbook computer, a personal computer (PC), a desktop computer, a personal digital assistant (PDA), a smart phone, or any programmable electronic device capable of communicating with server 170 over network 110. While in FIG. 1 only one computer, computer 120 is shown, computer 120 can represent one or multiple computers that may be used in conjunction with server 170 to create or edit an asset utilizing asset creation tools. Computer 120 includes internal and external hardware components, as depicted and described in further detail with respect to FIG. 5.

Computer 120 includes document creation program 121, asset creation tool 122 and User Interface (UI) 123. UI 123 displays data and receives input from an asset provider.

Document creation program 121 can be any currently available program for document or presentation creation and editing for example, Microsoft Office® or Lotus Symphony®.

Asset creation tool 122 is a “plug-in”, interface or other “macro” based program designed to augment the currently available programs (e.g. document creation program 121) in the creation of new assets or changing existing assets. Asset creation tool 122 includes information storage 124, administration 125, association 126 and notification 127. Asset creation tool 122 is designed to configure document creation program 121 to categorize, tag, link and segment assets into sections, subsets, and groups for entry into asset system 160. Asset creation tool 122 provides the capability to make granular, identifiable elements which have asset provider defined points of variability, links and identified list of collaborators.

Information system 124 provides the ability for the appropriate asset information to be stored with the local system (e.g. computer 120), as well as with an asset system (e.g. asset system 160). The local assets may be stored in memory or persistent storage, for example a database or other resident storage in computer 120. Additionally, if desired, the asset may be stored in removable storage such as disks, thumb drives or a backup hard drive. The ability to store appropriate asset information occurs in support of each capability provided by the asset creation tool. As illustrated in FIG. 1, the appropriate network connections exist in network 110 between computer 120 and the asset system 160, and provide the appropriate security, data synchronization, and data redundancy.

Administration 125 can prompt the user for connection to asset system 160 at configuration. Preferences may be set by the asset provider for subsequent connections with the asset system to occur at the initiation of asset creation tool 122 or when an asset is saved. In some embodiments, administration 125 also provides the ability for an asset provider to configure their system to notify the identified collaborating asset providers when configuration is performed, or when appropriate updates are made by an asset provider and an asset is saved. Asset creation tool 122 enables the asset providers to determine if notification is appropriate at file save. Additionally, in some embodiments, the various asset providers may configure how often they will want to receive notifications overriding configurations of other asset providers who may send notifications of updates.

Association 126 provides the ability for the asset provider to identify a target assembly within the asset system. Association 126 also provides the ability to configure the identification of other asset providers collaborating on an asset. Association 126 leverages the capabilities provided by administration 125 to notify collaborators. Proper identification of collaborators and the appropriate sections, subsets or groups corresponding to the collaborators ensures effective set-up of collaborative teams. Association 126 can be configured to notify asset system 160, as well as other asset providers of new asset subsets, sections or groups when a file which is associated with an asset system or a target assembly within the asset system is saved.

Another capability provided by association 126 is the ability for an asset provider to create appropriate metadata about associated aspects of an asset or asset section, subset, or group. For example, the identification of a group of slides or a group of paragraphs to be represented as a single entity within asset system 160 may be enabled via association 126. Additionally, association 126 may provide the ability to have an asset provider create new points of variability within an asset. The new variables may be identified and made known to asset system 160, as well as other asset providers, when a file associated with the asset system is saved. Association 126 is configured to provide ability to link various forms of content with asset system 160.

Notification 127 enables the notification to various asset providers that an asset subset or section has been updated into asset system 160. The asset provider updating an asset subset or section can determine if they would like to enable the asset system to notify collaborating asset providers of the update. In some embodiments, asset creation tool 122 may configure document creation program 121 on the local system (e.g. computer 120) to send notification of asset changes from computer 120 to collaborators via user id or other electronic communication identification over network 110. In addition, asset providers can register their interest on receiving notifications of asset updates for assets that they are a collaborating asset provider on.

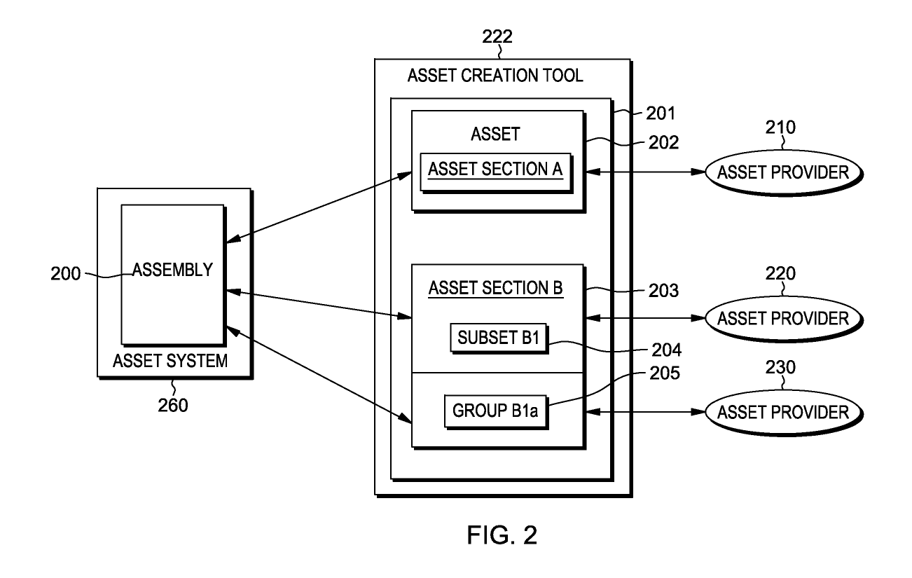

FIG. 2 is a schematic diagram illustrating an example of an asset creation tool generating an asset, in accordance with an embodiment of the present invention.

In FIG. 2, asset creation tool 222 is used to configure a document creation program to create asset 201, which may be a presentation on the world economy. Asset 201 may be configured by asset provider 210 to identify the sections of asset 201. Asset provider 210 in generating asset 201 and section A 202 may be prompted to identify a target assembly in asset system 260 to store asset 201 and section A 202. A target assembly may contain one or more documents, presentations, files or related electronic content on similar subjects or topics. For example, assembly 200 in asset system 260 may be labeled “Finance and Economy” and contain those assets pertaining to finance and economy. Asset provider 210 creates asset section A 202 which may be “South American Economy” for example and identifies the target assembly, assembly 200.

Assembly 200 in asset system 260 can provide a list of potential collaborators to asset provider 210. This list could be provided from a list of previous asset providers on assets with “economy” in the asset title, section title, subset title, group title, or identified by the subject “economy” in metadata or similar coded identification information. Upon receipt of the list of potential asset providers, asset provider 210 selects the appropriate desired collaborators for section A 202 and subsequent sections B 203, subset B1 204 or group B1a 205. Asset creation tool 222 provides the ability to add collaborators to the list of potential collaborators after initial set-up. Some embodiments may allow asset provider 210 to compile the complete list of collaborators for all asset sections, subsets, or groups of asset 201. The list of collaborators for section A 202 may be sent to asset system 260.

When asset provider 210 completes creation of section A 202 and saves section A 202, the asset creation tool saves asset section A 202 to the local system, for example computer 120, and asset system 260. At asset save, asset creation tool 222 may query asset provider 210 with a “Yes” or “No” prompt for asset provider 210 to identify if notification to collaborators is required for the changes. If asset provider 210 selects “Yes”, then the request for notification is included with the saved asset section A 202. When section A 202 is saved to asset system 260, it prompts asset system 260 to generate notification of changes to section A 202 identified collaborators. If asset provider 210 selects “No” then no notification of changes will be sent out.

Asset provider 220 may follow the same process for creating section B 203 as used in creating section A 202. In addition, asset provider 220 may create a subset, subset B1 204 as a more granular element of section B 203. Subset B1 204 for example may be 20 slides on Brazil's economy. While subset B1 204 is also generated by asset provider 220, it may have different collaborators or some different collaborators, metadata, tabs, links and/or tags than section B. Similar processing occurs at save as discussed for section A.

Asset provider 230 may provide even a further granular element, group B1a 205 of asset 201. Group B1a 205, for example, may be a set of three slides on Brazil's agriculture. Group B1a 205 may have the same collaborators as subset B1 204 or its own set of collaborators, associated metadata, tabs, links or tags associated with it. As with the previous sections or subsets, asset system 260 may provide a list of potential collaborators which may be selected and/or added to by asset provider 230. Asset provider 230 identifies the collaborators for group B1a 205 and assembly for asset system 260. Notification of changes may be generated by asset system 260 upon asset provider 230's recommendation at save. The process and steps for notification can be executed similar to section A 202.

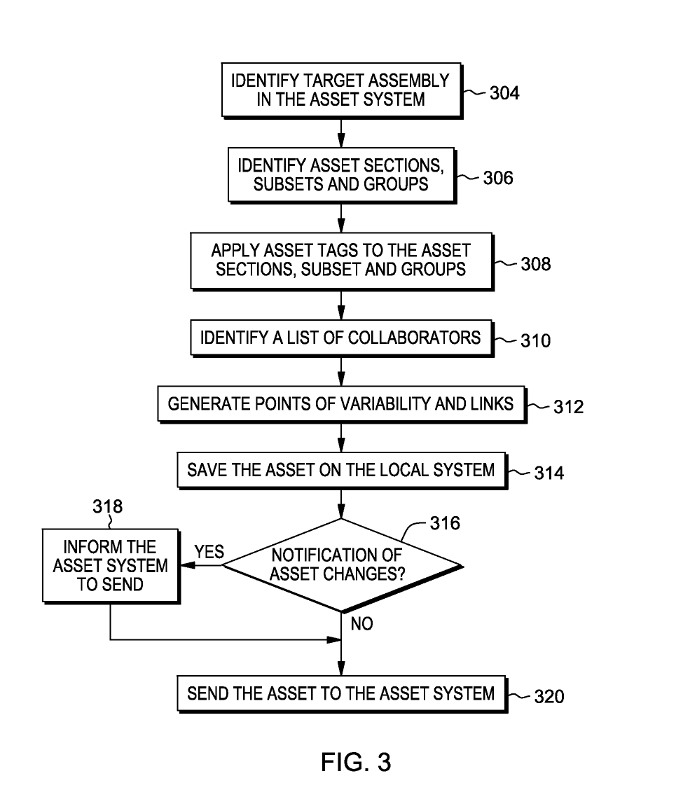

FIG. 3 is a flowchart depicting operational steps of an asset creation tool within the data processing environment of FIG. 1, in accordance with an embodiment of the present invention.

In step 304, asset creation tool 122 identifies a target assembly in the asset system. A user or asset provider creates or edits a document, presentation or other file within document creation program 121 which may be configured to automatically open asset creation tool 122. The asset provider inputs a target assembly via UI 123. Asset creation tool 122 configures document creation program to identify the target assembly the asset is associated with, and configures the asset for entry into the target assembly in asset system 160. For example, asset creation tool 122 at asset, section, subset, or group creation may provide an additional line or active field to existing document creation program 121 for identifying a target assembly to store or add the asset to asset system 160. When clicked on, this line, icon or active field may provide a drop down menu of existing assemblies to be selected for asset entry. In some embodiments, asset creation tool 122 may receive from the asset provider a request to send a configuration for a new assembly to be created in asset system 160 for the asset. Asset creation tool 122 will use this information to connect to asset system 160 via network 110.

In step 306, asset creation tool 122 identifies asset sections, subsets and groups within the asset. Asset creation tool 122 retrieves from asset system 160 a list of available asset sections, subsets, subgroups, points of variability and collaborator lists for the asset when an asset provider is editing an asset. In addition, in some embodiments, asset creation tool 122 configures document creation program 121 to have asset system 160 provide a list of available asset sections, subsets, subgroups, points of variability and collaborator lists for the assembly. The appropriate identification of sections, subset and groups allows a granular structure, or a “breaking-up”, of the asset into smaller, more useable elements.

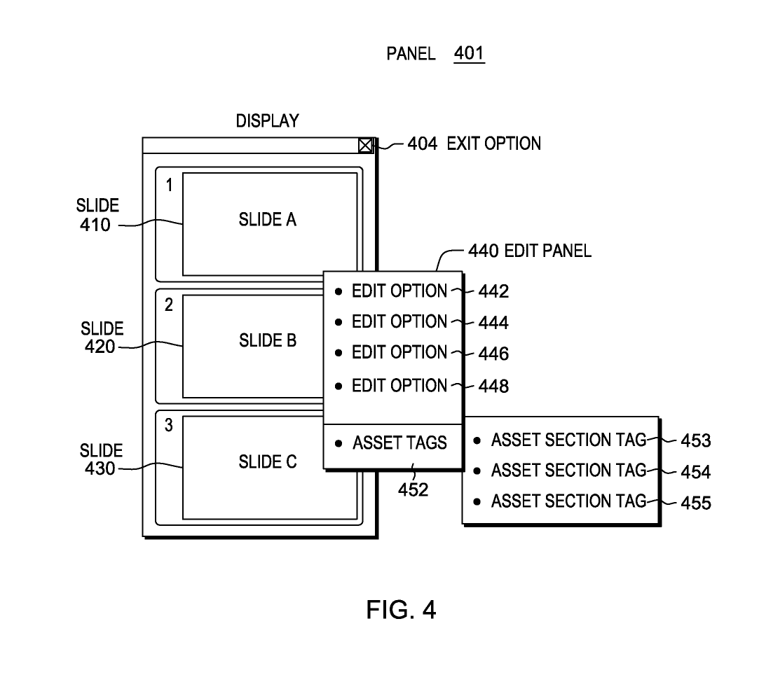

For example, an asset, such as a document on cognitive computing, may identify a subset on potential applications, and further identify within that subset a group of 4 paragraphs on simulated neural nets. The asset provider can identify sections, subsets and groups as appropriate via UI 123. The asset sections, subsets and groups are configured by asset creation tool 122 within document creation program 121 to be transmitted to asset system 160 upon saving the asset. An example of how the assets, sections, subsets and groups may be displayed on UI 123 within existing document creation program 121 is shown later in FIG. 4.

In step 308, asset creation tool 122 configures document creation program 121 to apply tags to the asset sections, subsets and groups. Tags are identifiers or description language that may be placed within an asset to direct how an asset is manifested in an asset system 160 user interface, such as UI 123. A tag may identify modifications to an asset representation in the asset system. Asset creation tool 122 may configure existing document creation program 121 for a user to select “factory tags” on UI 123. The factory tags may be configured for example under a new icon in the existing program menu, which when clicked on or activated may show a drop-down menu with section, subset and group tags within the asset section subset or group. FIG. 4 includes an example of factory tags.

In some embodiments, asset creation tool 122 provides the capability for an asset provider to retrieve points of variability and tags, as well as collaborator lists, from asset system 160 in step 304 for existing assets. In other embodiments of the present invention, asset creation tool 122 configures document creation program 121 to enable the asset provider to include existing tags such as “bold”, “italize”, “group”, etc to customize and manifest the associated aspects of the asset, section, subset or group within asset system 160. For example, use of the “group” tag in a presentation indicates that the slides are being grouped together in asset system 160, and represented as a single group entity.

When asset system 160 executes the selected tag, asset system 160 can appropriately represent the section, subset or group with asset system 160 user interface (e.g. UI 123). For example, in an asset “World Economy”, a group tag identified as “Brazil's agriculture” is listed. When selected, “Brazil's agriculture” will show 3 slides with the appropriate slide titles listed along with any other asset provider selected comments. The granular de-composition and configuration of assets into tagged or identifiable sections, subsets and groups provides detailed access to desired information within a large document, presentation or file.

In step 310, asset creation tool 122 identifies a list of collaborators working on the asset. In some embodiments, the list of identified collaborators may include individuals not collaborating on this asset or assembly that this asset is a part, but who are working on related subjects or projects. As an asset provider creates a new asset, asset creation tool 122 will prompt the asset provider for collaborators. Asset creation tool 122 upon request of a new asset, reviews input on target assembly and sends a request to the asset system 160 for a list of asset collaborators for that assembly. The list of assembly asset providers received from asset system 160 is displayed by asset creation tool 122 for the asset provider to click on or otherwise select collaborators. Additionally, asset creation tool 122 provides the ability for asset provider 210 to enter or register new collaborators to their asset by typing a name, user id, and other desired identification in the asset creation tool provided collaborator entry screen on UI 123. Using the identified list of collaborators, asset creation tool 122 may configure both computer 120 and asset system 160 to notify collaborators of changes to the asset or asset status. Asset creation tool 122 provides further capability to identify the collaborators by section, subset and group. This targeted or selective identification of collaborators prevents unnecessary disruption of co-workers activities. For example, an asset provider developing an asset, such as a presentation on the world economy may include a section on China's economy with a subset on China's manufacturing. Another section may be created on South American economy with a subset on Brazil's economy, and a group of three slides on Brazil's agriculture. Collaborators may be identified for each group, subset and section. The asset provider may not choose to list the asset providers associated with China's manufacturing as collaborators for the group of slides on Brazil's agriculture. The ability to identify and configure lists of specific collaborators as deemed appropriate for sections, subsets and groups provides efficient and effective notifications of changes to targeted information rather than notifications of changes to the asset in its totality.

In step 312, asset creation tool 122 configures the document creation program 121 so that it may generate points of variability linked to related content for the asset. Points of variability can be represented by leveraging standard document elements, for example SmartArt®, text fields, or table fields of an asset that may change. Presenter name, date of presentation, the audience presented to, or other custom variability points (e.g. stock quote feeds, calendar fields or calculations) may be identified by the asset provider as a point of variability. A point of variability may be identified by using a specific placeholder (e.g. document element) created within the asset. The point of variability placeholder is replaced by the asset system 160 in real-time when an asset is generated by the asset system 160. The points of variability may be activated or utilized when the asset is customized, generated, or saved.

In step 314, asset creation tool 122 saves the asset, the asset section, the subset and/or the group on the local computer system, such as computer 120. Asset creation program 122 configures document creation program 121 to save the asset, sections, subsets and/or groups with identified collaborators, points of variability, and tags in the local system (e.g. computer 120) and the target assembly in asset system 160.

In step 316, asset creation tool 122 configures document creation program 121 to determine if notification of the asset changes are to be sent to the list of collaborators for that asset, section, subset or group of the asset. When asset creation tool 122 saves an asset, a section, a subset or a group, it will automatically prompt the asset provider to identify if a notification of a change in the asset should be sent. Asset creation tool 122 may configure document creation program 121 to prompt the asset provider via UI 123 with, a Yes or No button, for example, that asset provider selects for collaborator notification. If the asset provider selects Yes, then the process proceeds to step 318 (“YES” branch of FIG. 3). If the asset provider selects No, then the process proceeds to step 320 (“NO” branch of FIG. 3).

In step 318, asset creation tool 122 informs the asset system 160 of the need for collaborator notification. If the asset provider determines that the changes are significant and warrant updating team members and collaborators, asset creation tool 122 can identify this to asset system 160. Asset system 160 may send notifications, for example e-mails, to the list of asset collaborators. Asset creation tool 122 configures document creation program 121 to allow the asset provider to select which sections, subsets or groups of the asset require notification to their respective list of collaborators rather than sending a notification to all collaborators on the presentation, document or similar asset. In some embodiments, the asset sections, subsets or groups updated or created may be sent with the notification.

In step 320, asset creation tool 122 configures document creation program 121 to send the asset to the asset system 160. The asset as configured by asset creation tool 122 creates the desired manifestation within asset system 160. The asset may be sent as identified by asset creation tool 122 to an assembly in asset system 160 where assets may be processed as required by asset control program 166 and saved in asset database 165.

FIG. 4 depicts an example of an extension provided by asset creation tool 122, in accordance with one embodiment of the present invention. FIG. 4 depicts an example of how the granular elements in an asset (e.g. sections, subsets or groups) may be displayed on UI 123 by document creation program 121 as configured by asset creation tool 122. Edit panel 440 may contain additional edit options, not shown in this example. In some embodiments, an asset provider may select to add edit panel 440 to a tool bar or other specific target location in document creation program 121. Edit panel 440 includes a number of edit options displayed on UI 123. Edit option 442 may be “cut” for example and edit option 444 may be “copy”. Edit option 446 may be “new slide” while Edit option 448 may be “delete slide”. Asset creation tool 122 configures document creation program 121 to modify edit panel 440 as shown to enable the addition of asset tags 452 and associated asset section tags 453, asset subset tags 454, and asset group tags 455. Asset tags 452 and associated asset section tags 453, asset subset tags 454 and asset group tags 455 may be in a menu or drop down screen as illustrated in FIG. 4. An asset provider may click on asset tags 452 which will show a menu of different tags associated with the asset being worked with. For example, in the “World Economy” presentation discussed previously, asset group tag 455 could be “Brazil's Agriculture” (Group B1a in FIG. 2). Additionally, in some embodiments, other tags associated with the asset, section, subset or group such as “bold”, “italics”, or similar tags may be used.

In some embodiments, multiple sections, subsets and/or groups may exist in an asset. In FIG. 4, when the asset provider has selected asset section tag 453, UI 123 displays one or more sections in the asset in a drop down menu. An asset provider may select a section to work on by clicking on that section. Additionally, a line or icon may be provided to create a new section. Any subsets associated with the selected section, may be displayed on UI 123 along with a line or icon with the option to create a new subset. Similarly, when an asset provider selects a subset, any associated groups are shown on UI 123 along with the option to create a new group.

In FIG. 4, the asset is displayed as a presentation with slides, for example, Slide A, Slide B and Slide C. Display panel 401 displays the various elements of the asset, as slides in this example, however, in other embodiments; an outline may be displayed for a document. When an asset provider selects a slide, Slide B for example, to enter into a group, the asset provider can click on the desired asset tag 452, asset section tag 453, asset subset tag 454 and group tag 455. As is usual for document creation tools, one or more slides can be selected. If no appropriate group tag exists for the asset, then, the user is presented the opportunity to create a new group tag name which will subsequently appear in the display.

In the world economy example discussed earlier, Slide A, Slide B, and Slide C may be the group of slides on Brazil's agriculture. An asset provider may select Slide A for editing by clicking on these slides within display panel 401. Additionally, display panel 401 includes exit option 404 illustrated as X which will minimize the elements in display panel 401. An asset provider can use their tool bar or other document creation tool mechanism to redisplay display panel 401. The example in FIG. 4 depicts a slide presentation as an asset. In other embodiments, a similar technique of highlighting outline elements of a document or paragraphs within a document could be utilized to show how asset tags 452 could be associated with document outline sections or paragraphs.

In embodiments of the present invention, each asset provider can chose how to effectively segment an asset into granular elements such as sections, subsets, and/or groups, tag the elements (e.g. sections, subsets and/or groups) with appropriate information, points of variability and desired formats. Additionally, embodiments of the present invention enable asset providers to identify one or more collaborators for the various identified groups, subsets and sections of an asset and provide selective notification of asset changes. Configuration of existing document creation programs by asset creation tool 122 allows expanded capabilities, customization and identification of granular elements of an asset for effective entry and use by an asset system 160.

FIG. 5 depicts a block diagram, 500, of respective components of computer 120 and server 170 in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Computer 120 and server 170 include respective communications unit 510, which provides communications between respective computer processor(s) 504, memory 506, persistent storage 508, communications unit 510, and input/output (I/O) interface(s) 512. Communications fabric 502 can be implemented with any architecture designed for passing data and/or control information between processors (microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 514 and cache memory 516. In general, memory 506 can include any suitable volatile or non-volatile computer-readable storage media.

Document creation program 121, UI 123, asset creation tool 122, information system 124, administration 125, association 126, notification 127, asset control program 166 and asset database 165 are stored in respective persistent storage 508 for execution and/or access by one or more of the respective computer processor(s) 504 via one or more memories of respective memory 506. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 508.

Communications unit 510, in these examples, provides for communications with other data processing systems or devices, including resources of network 110 and server 170. In these examples, communications unit 510 includes one or more network interface cards. Communications unit 510 may provide communications through the use of either or both physical and wireless communications links Document creation program 121, UI 123, asset creation tool 122, information system 124, administration 125, association 126, notification 127, asset control program 166 and asset database 165 may be downloaded to respective persistent storage 508 through further respective communications unit 510.

I/O interface(s) 512 allows for input and output of data with other devices that may be connected to computer 120. For example, I/O interface(s) 512 may provide a connection to external device(s) 518 such as a keyboard, a keypad, a touch screen, and/or some other suitable input device. External device(s) 518 can also include portable computer-readable storage media such as, for example, thumb drives, portable optical or magnetic disks and memory cards. Software and data used to practice embodiments of the present invention, e.g., asset creation tool 122, UI 123 and document creation program 121, can be stored on such portable computer-readable storage media and can be loaded onto persistent storage 508 via I/O interface(s) 512. I/O interface(s) 512 also connect to a display 520.

Display 520 provides a mechanism to display data to a user and may be, for example, a computer monitor. Display 520 provides a mechanism to display data to a user using UI 123 and may be, for example, a computer monitor or an incorporated display screen, such as is used in tablet computers and smart phones.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method of configuring an existing document creation program, the method comprising:
configuring, by the computer, the existing document creation program to format an asset, for entry into an asset system, with one or more portions of the asset;
configuring, by the computer, the existing document creation program to identify to the asset system, a list of collaborators; and
configuring, by the computer, the existing document creation program to identify to the asset system a change in the one or more portions of the asset for collaborator notification.

2. A method of claim 1, wherein configuring by the computer, the existing document creation program to format the asset, for entry into the asset system, with one or more portions of the asset includes:
configuring, by the computer, the existing document creation program to generate a query to an asset provider, who is submitting one or more portions of the asset for entry into the asset system, to determine if the change in the asset requires collaborator notification.

3. A method of claim 1, wherein configuring, by the computer, the existing document creation program to identify, to the asset system, the list of collaborators includes:
configuring, by the computer, the existing document creation program to receive a list of asset collaborators, based on, at least in part, on the list of potential asset collaborators from the asset system and input received from an asset provider.

4. A method of claim 1, wherein configuring, by the computer, the existing document creation program to identify, to the asset system, the list of collaborators includes:
configuring by the computer, the existing document creation program to identify a list of collaborators for each of the one or more portions of the asset.

5. A method of claim 1, wherein the one or more points of variability are included in the one or more of the portions of the asset.

6. A method of claim 5, wherein configuring the existing document creation program to format the asset for entry into the asset system includes enabling dynamic updates to points of variability.

7. A method of claim 1, wherein formatting an asset can include use of one or more tags to identify modifications to an asset representation in an asset system.

8. A computer program product for configuring an existing asset creation tool, the computer program product comprising:
one or more computer-readable storage media and program instructions stored on the one or more computer-readable storage media, the program instructions comprising:
program instructions to configure, by the computer, the existing document creation program to format an asset, for entry into an asset system, with one or more of portions of the asset;
program instructions to configure, by the computer, the existing document creation program to identify to the asset system, a list of collaborators; and
program instructions to configure, by the computer, the existing document creation program to identify to the asset system, a change in the one or more portions of the asset for collaborator notification.

9. The computer product of claim 8, wherein configuring by the computer, the existing document creation program to format the asset, for entry into the asset system, with one or more portions of the asset includes:
configuring, by the computer, the existing document creation program to generate a query to an asset provider, who is submitting one or more portions of the asset for entry into the asset system, to determine if the change in the asset requires collaborator notification.

10. The computer product of claim 9, wherein configuring, by the computer, the existing document creation program to identify, to the asset system, the list of collaborators includes:
configuring, by the computer, the existing document creation program to receive a list of asset collaborators, based on, at least in part, on the list of potential asset collaborators from the asset system and input received from an asset provider.

11. The computer product of claim 8, wherein configuring, by the computer, the existing document creation program to identify, to the asset system, the list of collaborators includes:
configuring by the computer, the existing document creation program to identify a list of collaborators for each of the one or more portions of the asset.

12. The computer product of claim 8, wherein the one or more points of variability are included in the one or more of the portions of the asset.

13. The computer product of claim 12, wherein configuring the existing document creation program to format the asset for entry into the asset system includes enabling dynamic updates to points of variability.

14. The computer product of claim 10, where formatting an asset can include use of one or more tags to identify modifications to an asset representation in an asset system.

15. A computer system for configuring an existing document creation program, the computer system comprising:
one or more computer processors;
one or more computer-readable storage media;
program instructions stored on the computer-readable storage media for execution by at least one of the one or more processors, the program instructions comprising:
program instructions to configure, by the computer, the existing document creation program to format an asset, for entry into an asset system, with one or more portions of the asset;
program instructions to configure, by the computer, the existing document creation program to identify, to the asset system, a list of collaborators; and
program instructions to configure, by the computer, the existing document creation program to identify to the asset system a change in the one or more portions of the asset for collaborator notification.

16. The computer system of claim 15, wherein configuring by the computer, the existing document creation program to format the asset, for entry into the asset system, with one or more portions of the asset includes:
configuring, by the computer, the existing document creation program to generate a query to an asset provider, who is submitting one or more portions of the asset for entry into the asset system, to determine if the change in the asset requires collaborator notification.

17. The computer system of claim 16, wherein configuring, by the computer, the existing document creation program to identify, to the asset system, the list of collaborators includes:
configuring, by the computer, the existing document creation program to receive a list of asset collaborators, based on, at least in part, on the list of potential asset collaborators from the asset system and input received from an asset provider.

18. The computer system of claim 15, wherein configuring, by the computer, the existing document creation program to identify, to the asset system, the list of collaborators includes:
configuring by the computer, the existing document creation program to identify a list of collaborators for each of the one or more portions of the asset.

19. The computer system of claim 15, wherein the one or more points of variability are included in the one or more of the portions of the asset.

20. The computer system of claim 19, wherein configuring the existing document creation program to format the asset for entry into the asset system includes enabling dynamic updates to points of variability.
